(19) United States
(12) Patent Application Publication
(10) Pub. No.: US 2026/0189868 A1
(43) Pub. Date: Jul. 2, 2026

(54) AUDIO DATA TRANSMISSION SYSTEM

(71) Applicant: HARBOR TECHNOLOGY SOLUTIONS CO., LTD., Taipei City (TW)

(72) Inventor: Hung-Yi LU, Taipei City (TW)

(21) Appl. No.: 19/002,763

(22) Filed: Dec. 27, 2024

(51) Int. Cl. H04S 7/00; H04S 3/00

(52) U.S. Cl. CPC H04S 7/00; H04S 3/008; H04S 2400/01

(57) ABSTRACT

An audio data transmission system includes at least one data transmission terminal, a first conversion module, a second conversion module, and at least one data receiving terminal. The first conversion module converts a digital format of an original digital data into a digital audio format to acquire a digital audio data. The second conversion module converts a digital audio format of the digital audio data into the digital format of the original digital data. A multi-channel structure of the digital audio format is applied so that at least one channel is formed between the first conversion module and the second conversion module, and the digital audio data is transmitted through the at least one channel, thereby achieving the effect of fast data transmission. Accordingly, whether it is before or after data transmission, the conversion technology of digital data format and method, is obviously different from the conventional application.

### TECHNICAL FIELD OF THE INVENTION

The present disclosure relates to a data transmission system, and more particularly to a data transmission system for converting a digital format of an original digital data into a digital audio format to format the original digital data into a digital audio data so that the digital audio data can be transmitted through at least one channel.

### DESCRIPTION OF RELATED ART

The statements in this section merely provide background information related to the present disclosure and do not necessarily constitute prior art.

Most of the existing data transmission is usually digital data transmission, and the data transmission rate is usually determined by the transmission protocol and the transmission equipment. Most of the existing problems with digital data transmission are that when large amounts of data are transmitted, the transmission protocol needs to confirm the correctness of the data and compress and decompress the data, resulting in delays in data transmission.

The digital audio format itself has the characteristics of supporting multi-channel mode. By using this multi-channel mode, the original digital data is first converted into digital audio data, and then the digital audio data can be transmitted through multiple channels. Since there can be a plurality of channels, multiple digital audio data can be synchronously transmitted through the plurality of channels to transmit multi-channel data, thereby effectively increasing the speed of data transmission.

However, in a conventional application, after analog sound is received by a conventional microphone, an analog-to-digital conversion is applied to convert the analog audio into digital audio, and then the digital audio is transmitted. Finally, a digital-to-analog conversion is applied to convert the digital audio back into the analog sound for playback. Although these conversion technologies are applied to audio conversion technology, when compared to the present disclosure, whether it is before or after data transmission, the conversion technology of digital data format and method, is obviously different from the conventional application.

### SUMMARY OF THE INVENTION

An objective of the present disclosure is to provide an audio data transmission system to convert a digital format of an original digital data into a digital audio format to format the original digital data into a digital audio data, and the digital audio data can be transmitted through multiple channels.

In order to achieve the above-mentioned objective, the audio data transmission system includes at least one data transmission terminal, a first conversion module, a second conversion module, and at least one data receiving terminal. The at least one data transmission terminal provides an original digital data. The first conversion module includes a first receiving unit, a first processing unit, and a first transmission unit. The first receiving unit receives the original digital data, the first processing unit converts a digital format of the original digital data into a digital audio format to format the original digital data into a digital audio data, and the first transmission unit outputs the digital audio data. The second conversion module includes a second receiving unit, a second processing unit, and a second transmission unit. The second receiving unit receives the digital audio data, the second processing unit converts a digital audio format of the digital audio data into the digital format of the original digital data to format the digital audio data into the original digital data, and the second transmission unit outputs the original digital data. The at least one data receiving terminal receives the original digital data transmitted by the second transmission unit. After the digital format of the original digital data is converted into the digital audio format, a multi-channel structure of the digital audio format itself is applied so that at least one channel is formed between the first conversion module and the second conversion module, and the digital audio data is transmitted through the at least one channel.

Therefore, first, the first conversion module is used to convert the digital format of the original digital data provided by the data transmission terminal into the digital audio format so as to format the original digital data into the digital audio data. Afterward, the digital audio data can be transmitted through the at least one channel so that a large amount of data can be transmitted quickly. Afterward, the second conversion module is used to convert the digital audio format of the digital audio data into the digital format of the original digital data so as to format the digital audio data into the original digital data, and to output the original digital data. Finally, the data receiving terminal receives the original digital data.

Accordingly, the present disclosure can achieve the effect of fast data transmission.

In particular, the digital format of the original digital data provided by the data transmission terminal is converted into the digital audio format, and then to perform the data transmission. Afterward, the digital audio format of the digital audio data is converted into the digital format of the original digital data. Finally, the data receiving terminal can receive the original digital data. However, in the conventional application, after analog sound is received by a conventional microphone, the analog audio is converted into the digital audio for transmission, and finally the digital audio is converted back into the analog sound for playback. Therefore, for the present disclosure, both the first conversion module and the second conversion module are provided for digital-to-digital conversions (rather than an analog-to-digital conversion or a digital-to-analog conversion), whether it is before or after data transmission, the conversion technology of digital data format and method, is obviously different from the conventional application.

It is to be understood that both the foregoing general description and the following detailed description are exemplary, and are intended to provide further explanation of the present disclosure as claimed. Other advantages and features of the present disclosure will be apparent from the following description, drawings, and claims.

### BRIEF DESCRIPTION OF DRAWINGS

The present disclosure can be more fully understood by reading the following detailed description of the embodiment, with reference made to the accompanying drawing as follows:

FIG. 1 is a schematic diagram of an audio data transmission system according to the present disclosure.

FIG. 2 is a structural block diagram of the audio data transmission system according to the present disclosure.

### DETAILED DESCRIPTION

Reference will now be made to the drawing figures to describe the present disclosure in detail. It will be understood that the drawing figures and exemplified embodiments of present disclosure are not limited to the details thereof.

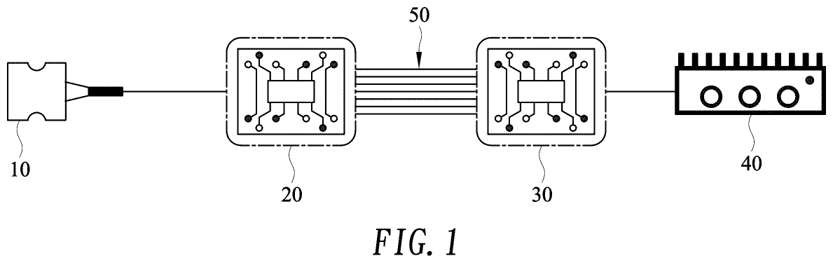

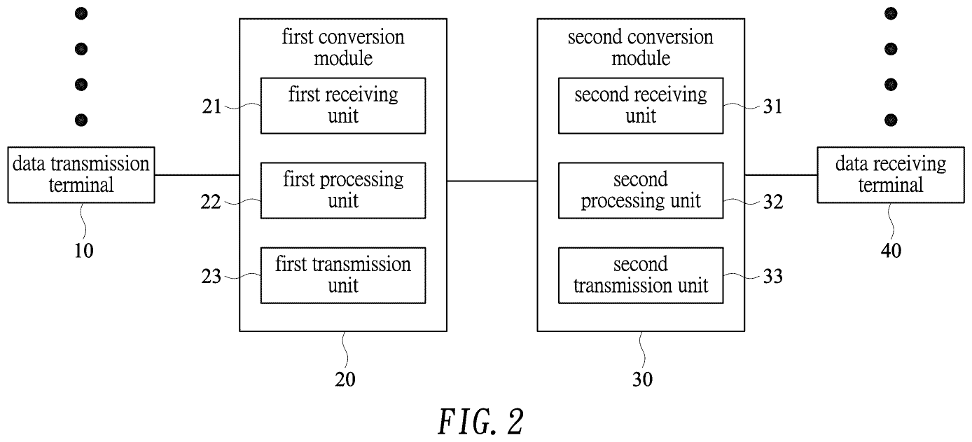

Please refer to FIG. 1, which shows a schematic diagram of an audio data transmission system according to the present disclosure; please refer to FIG. 2, which shows a structural block diagram of the audio data transmission system according to the present disclosure.

As shown in FIG. 1 and FIG. 2, the audio data transmission system of the present disclosure includes at least one data transmission terminal 10, a first conversion module 20, a second conversion module 30, and at least one data receiving terminal 40, which will be explained in detail below.

The at least one data transmission terminal 10 provides an original digital data, that is, the at least one data transmission terminal 10 has the original digital data.

The first conversion module 20 includes a first receiving unit 21, a first processing unit 22, and a first transmission unit 23. The first receiving unit 21 receives the original digital data, the first processing unit 22 converts a digital format of the original digital data into a digital audio format to format the original digital data into a digital audio data, and the first transmission unit 23 outputs the digital audio data.

The second conversion module 30 includes a second receiving unit 31, a second processing unit 32, and a second transmission unit 33. The second receiving unit 31 receives the digital audio data, the second processing unit 32 convert a digital audio format of the digital audio data into the digital format of the original digital data to format the digital audio data into the original digital data, and the second transmission unit 33 outputs the original digital data.

The at least one data receiving terminal 40 receives the original digital data transmitted by the second transmission unit 33.

After the digital format of the original digital data is converted into the digital audio format, a multi-channel structure of the digital audio format itself is applied so that at least one channel 50 is formed between the first conversion module 20 and the second conversion module 30, and the digital audio data is transmitted through the at least one channel 50.

In one embodiment of the present disclosure, the digital audio format is one of MP3, WAV, WMA, MP2, FLAC, MIDI, PCM, RA, APE, AAC, CDA, and MOV.

In one embodiment of the present disclosure, the data transmission terminal 10 is a sensor, and the sensor is one of a vibration sensor, a temperature sensor, a current sensor, a rotation speed sensor, a pressure sensor, and a flow rate sensor, but is not a microphone.

In one embodiment of the present disclosure, the data receiving terminal 40 is one of a gateway, a server, and an electric device.

In one embodiment of the present disclosure, the first conversion module 20 and the second conversion module 30 transmit data to each other through one of a universal serial bus, an Ethernet, and a Bluetooth module.

Therefore, the present disclosure has the following features and advantages:
The data transmission terminal 10 of the present embodiment may be selected from a vibration sensor, and the original digital data may be a vibration sensing data sensed by the vibration sensor.

First, the first conversion module 20 is used to convert the digital format of the original digital data provided by the data transmission terminal 10 into the digital audio format so as to format the original digital data into the digital audio data. Afterward, the digital audio data can be transmitted through the at least one channel 50 so that a large amount of data can be transmitted quickly.

It should be emphasized that when there is a plurality of channels 50, multiple digital audio data can be synchronously transmitted through the plurality of channels 50, and therefore a large amount of data can be transmitted quickly.

Afterward, the second conversion module 30 is used to convert the digital audio format of the digital audio data into the digital format of the original digital data so as to format the digital audio data into the original digital data, and to output the original digital data.

Finally, the data receiving terminal 40 receives the original digital data.

Accordingly, the present disclosure can achieve the effect of fast data transmission.

In particular, the digital format of the original digital data provided by the data transmission terminal 10 is converted into the digital audio format, and then to perform the data transmission. Afterward, the digital audio format of the digital audio data is converted into the digital format of the original digital data. Finally, the data receiving terminal 40 can receive the original digital data. However, in conventional application, after analog sound is received by a conventional microphone, the analog audio is converted into the digital audio for transmission, and finally the digital audio is converted back into the analog sound for playback. Therefore, for the present disclosure, both the first conversion module 20 and the second conversion module 30 are provided for digital-to-digital conversions (rather than an analog-to-digital conversion or a digital-to-analog conversion), whether it is before or after data transmission, the conversion technology of digital data format and method, is obviously different from the conventional application.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. An audio data transmission system comprising:
at least one data transmission terminal configured to provide an original digital data,
a first conversion module comprising a first receiving unit, a first processing unit, and a first transmission unit; the first receiving unit configured to receive the original digital data, the first processing unit configured to convert a digital format of the original digital data into a digital audio format to format the original digital data into a digital audio data, and the first transmission unit configured to output the digital audio data,
a second conversion module comprising a second receiving unit, a second processing unit, and a second transmission unit; the second receiving unit configured to receive the digital audio data, the second processing unit configured to convert a digital audio format of the digital audio data into the digital format of the original digital data to format the digital audio data into the original digital data, and the second transmission unit configured to output the original digital data, and
at least one data receiving terminal configured to receive the original digital data transmitted by the second transmission unit,
wherein after the digital format of the original digital data is converted into the digital audio format, a multi-channel structure of the digital audio format itself is applied so that at least one channel is formed between the first conversion module and the second conversion module, and the digital audio data is transmitted through the at least one channel.

2. The audio data transmission system as claimed in claim 1, wherein the digital audio format is one of MP3, WAV, WMA, MP2, FLAC, MIDI, PCM, RA, APE, AAC, CDA, and MOV.

3. The audio data transmission system as claimed in claim 1, wherein the data transmission terminal is a sensor.

4. The audio data transmission system as claimed in claim 3, wherein the sensor is one of a vibration sensor, a temperature sensor, a current sensor, a rotation speed sensor, a pressure sensor, and a flow rate sensor, but is not a microphone.

5. The audio data transmission system as claimed in claim 1, wherein the data receiving terminal is one of a gateway, a server, and an electric device.

6. The audio data transmission system as claimed in claim 1, wherein the first conversion module and the second conversion module are configured to transmit data to each other through one of a universal serial bus, an Ethernet, and a Bluetooth module.
